(19) United States
(12) Patent Application Publication
(10) Pub. No.: US 2014/0254456 A1
(43) Pub. Date: Sep. 11, 2014

(54) METHOD FOR COUNTING TERMINALS FOR MULTICAST/BROADCAST SERVICE

(71) Applicant: Electronics and Telecommunications Research Institute, (US)

(72) Inventor: Hyun-Suk ROH, Daejeon (KR)

(73) Assignee: Electronics and Telecommunications Research Institute, Daejeon (KR)

(21) Appl. No.: 13/790,895

(22) Filed: Mar. 8, 2013

(51) Int. Cl. H04L 12/18

(52) U.S. Cl. CPC H04L 12/18
USPC 370/312

(57) ABSTRACT

A method of a multicast/broadcast server to count the number of terminals. The method includes transmitting a request message to a base station to request to count the number of terminals currently being provided with one or more multicast/broadcast services or interested in the multicast/broadcast services; and switching mode of a corresponding service to unicast mode or multicast/broadcast mode according to whether the number of counted terminals is greater than a predefined threshold wherein the number of counted terminals is contained in a message received from the base station as a response to the request message.

### BACKGROUND

1. Field

The following description relates to a multicast/broadcast service in a WiMAX system, and more particularly, to a method for efficient use of radio resources by identifying the number of terminals currently using a particular service or being interested in the service.

2. Description of the Related Art

Generally, a communication system had developed more focusing on voice-oriented services, and is gradually evolving to provide more various services, such as data services and multimedia services. However, the conventional communication system uses narrow transmission bandwidth and is costly to use, so that it cannot sufficiently respond to growing user needs for services. Moreover, a need of an advanced communication system that can efficiently provide Internet services is increasing with the development of communication industries and an increase in user demand for Internet services. Accordingly, a broadband radio communication system has been adopted to allow bandwidth broad enough to satisfy the user needs and efficiently provide Internet services.

A radio connection method of a broadband radio connection system is standardized in Institute of Electrical and Electronics Engineers (IEEE) 802.16 working group. IEEE 802.16 provides wider bandwidth which allows for the transmission of more data within a shorter period of time, as compared to a conventional radio technique for voice-oriented services, and enables all users to share channels (or resources) so that the efficient use of channels is feasible.

For an IEEE 802.16 system, multicast and broadcast service (MBS) standards are established, according to which multicast and broadcast services are provided to a plurality of mobile terminals.

The MBS may be provided by transmitting the same broadcasting content over the same frequency, at the same time and from a number of base stations, unlike the existing unicast services and a receiving terminal receives packets from the different base stations and combines the packets to use, and thereby the reception performance can be increased.

The channels used for the MBS may be classified into common channels and dedicated channels according to a way of radio resource management schemes. The same broadcast service data is transmitted as MBS data bursts over the common channel, so that it can be prevented to waste radio resources for the same data. Data for each user is transmitted in unicast mode over dedicated channels.

However, the unicast service of the MBS may an unnecessary waste of radio resources.

### SUMMARY

The following description relates to a method of counting the number of terminals currently using a particular service or being interested in the service and switching mode of the corresponding service to unicast mode or MBS mode according to the counting result in an effort to prevent an unnecessary waste of radio resources due to a unicast service of MBS.

In one general aspect, there is provided A method of a multicast/broadcast server to count a number of terminals, comprising: transmitting a request message to a base station to request to count the number of terminals currently being provided with one or more multicast/broadcast services or interested in the multicast/broadcast services; and switching mode of a corresponding service to unicast mode or multicast/broadcast mode according to whether the number of counted terminals is greater than a predefined threshold wherein the number of counted terminals is contained in a message received from the base station as a response to the request message.

Other features and aspects will be apparent from the following detailed description, the drawings, and the claims.

### BRIEF DESCRIPTION OF THE DRAWINGS

FIG. 1 is a diagram illustrating a multicast and broadcast service (MBS) system to which the present invention is applicable.

FIG. 2 is a diagram illustrating a logical representation of WiMAX MBS architecture.

FIG. 3 is a signal flowchart for explaining a method of an MBS to count the number of terminals according to an exemplary embodiment of the present invention.

FIG. 4 is a flowchart illustrating a method of an MBS server to switch communication mode according to a result of counting the number of terminals.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

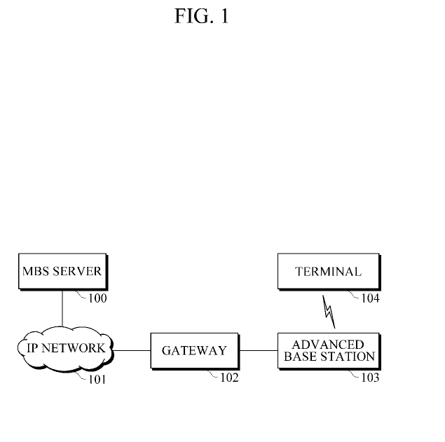

FIG. 1 is a diagram illustrating a multicast and broadcast service (MBS) system to which an exemplary embodiment of the present invention is applicable.

Referring to FIG. 1, an MBS server 100 provides a multicast and broadcast service in association with a content server (not shown), manages user terminals, and transmits multimedia traffic acquired from the content server to a terminal 104 via an Internet protocol (IP) network 101, a gateway and a base station 103.

In addition, the MBS server 100 manages an MBS zone.

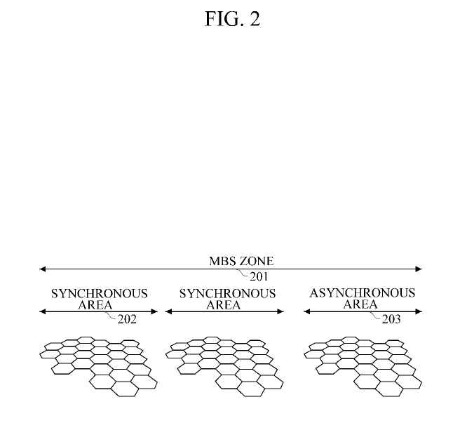

FIG. 2 is a diagram illustrating a logical representation of WiMAX MBS architecture.

Referring to FIG. 2, an MBS zone 201 in a WiMAX system may consist of a number of synchronous areas 202 and asynchronous areas 203. Base stations belonging to the synchronous areas 202 simultaneously transmit the same data in response to a radio resource synchronization signal. As a result, terminals placed at a position where the signal is strong in each synchronous area 202 are provided with high-bandwidth services, and terminals located at cell boundaries gain diversity effects. That is, interference from a neighboring base station serves as a gain. The MBS server 100 allocates radio resources of a base station placed in the synchronous area and is a multi-cell service related control entity.

Thus, the MBS server 100 according to the exemplary embodiment of the present invention requests the base station 103 via the gateway 102 to count the number of terminals currently using the MBS service or being interested in the MBS service, and determines shift of communication mode of a corresponding service in response to a received counting result. That is, the MBS server 100 determines unicast mode or MBS mode to transmit the corresponding service.

The gateway 102 receives multimedia traffic transmitted over the IP network 101 and transmits it to an advanced base station (ABS) 103, and internally provides an end-to-end service in response to a multicast service request.

The ABS 103 receives the multimedia traffic through the gateway 102 and transmits it to the terminal 104 via a radio interface. The ABS 103 counts the number of terminals 104 currently using an MBS service or being interested in the MBS service in response to the request from the MBS server 100, and transmits the counting result to the MBS server 100 via the gateway 102.

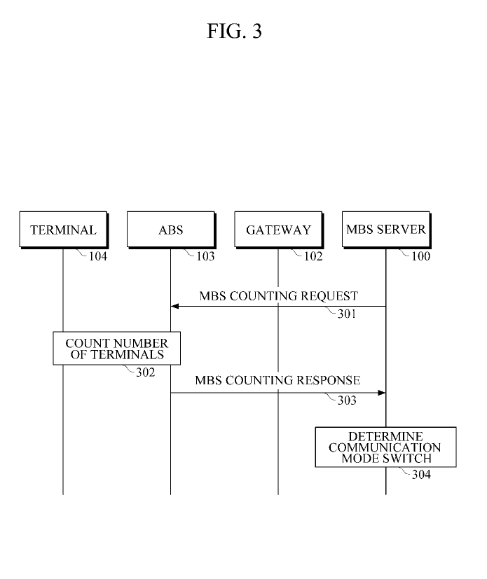

FIG. 3 is a signal flowchart for explaining a method of an MBS to count the number of terminals according to an exemplary embodiment of the present invention.

In response to a service request from a new user, an MBS server 100 may request a base station 103 to count the number of terminals related to services in a corresponding MBS zone. Then, the MBS server 100 switch mode of terminals related to the service to MBS mode or unicast mode based on the counting result.

Referring to FIG. 3, in operation 301, the MBS server 100 transmits an MBS counting request message to the base station 103 via a gateway 102. The MBS counting request message may include a list of services that require the counting of terminals.

In operation 302, the base station 103 counts the terminals for signal transmission/reception with one or more terminals 104.

Although not illustrated in drawings, more specifically, the base station 103 may transmit an inquiry message to the terminal 104 to ask whether to be provided with services listed in the service list that is contained in the MBS counting request message or whether to be interested in the services listed in the list. One of available message formats is an MBS scheduling information message used for transmitting MBS scheduling information, which can contain time information about duration of time for which the counting is performed. In response to the MBS counting request message, each terminal 104 may transmit a response message containing a list of the services currently being used or services of interest to the ABS 103.

In operation 303, the ABS 103 transmits, to the MBS server 100, an MBS counting response message containing a result of counting terminals related to each service based on the responses received from the terminals 104.

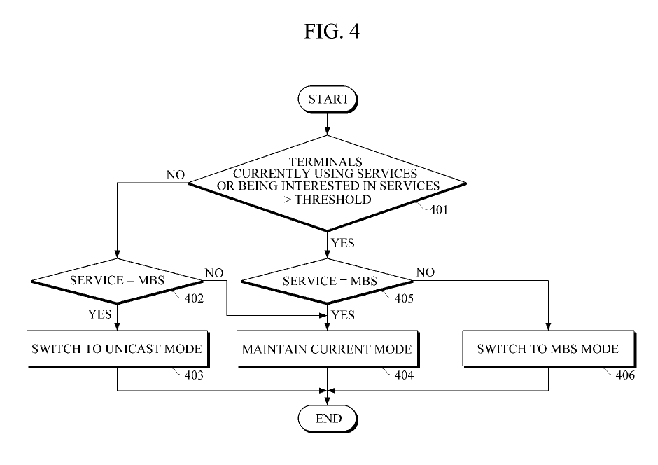

In response to the MBS counting response message, the MBS server 100 determines switch of communication mode for each terminal according to the result of counting the number of terminals, and this process will be described in detail with reference to FIG. 4.

FIG. 4 is a flowchart illustrating a method of an MBS server to switch communication mode according to a result of counting the number of terminals.

Referring to FIG. 4, an MBS server determines whether the number of terminals currently using a particular service or being interested in the service, that is, the terminal counting value, is greater than a predefined threshold based on a result of counting the terminals in a corresponding MBS zone in operation 401.

If it is determined in operation 401 that the number of counted terminals is smaller than the predefined threshold, the MBS server determines whether the particular service is one of MBS services in operation 403.

If it is determined in operation 402 that the relevant service is an MBS service, the MBS server switches the mode of the service to unicast mode. In contrast, if it is determined in operation 402 that the current service is not an MBS service, that is, the current service is in unicast mode, the MBS server maintains the current mode of the service. This is because resource waste may not incur in the course of provision of services in unicast mode when the number of counted terminals is smaller than the threshold.

If it is determined in operation 401 that the number of counted terminals is greater than the predefined threshold, the MBS server 100 determines whether the particular service is one of MBS services in operation 405.

If it is determined in operation 405 that the service is an MBS service, the MBS server maintains the current mode of the service. In contrast, if it is determined in operation 405 that the current service is not an MBS service, the MBS server switches mode of the service to MBS mode. A reason to switch to MBS mode is because resource waste may incur in the course of provision of services in unicast mode when the number of counted terminals is equal to or greater than the threshold.

As described above, according to the exemplary embodiments of the present invention, it is possible to reduce a waste of radio resources due to unnecessary data transmission by counting the number of terminals and identifying actual multicast and broadcast service users. In addition, the resources can be more efficiently used by switching mode of a plurality of unicast users to multicast mode or broadcast mode.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of a multicast/broadcast server to count a number of terminals, comprising:
transmitting a request message to a base station to request to count the number of terminals currently being provided with one or more multicast/broadcast services or interested in the multicast/broadcast services; and
switching mode of a corresponding service to unicast mode or multicast/broadcast mode according to whether the number of counted terminals is greater than a predefined threshold wherein the number of counted terminals is contained in a message received from the base station as a response to the request message.

2. The method of claim 1, wherein the message includes a list of services that require counting of a number of terminals.

3. The method of claim 1, wherein the switching of the mode of the corresponding service comprises,
if the number of counted terminals is smaller than the predetermined threshold, determining whether or not the corresponding service is currently a multicast/broadcast service and
in response to a determination being made that the corresponding service is a multicast/broadcast service, switching the mode of the service to unicast mode.

4. The method of claim 1, wherein the switching of the mode of the service comprises
if the number of counted terminals is smaller than the predetermined threshold, determining whether or not the corresponding service is currently a multicast/broadcast service and
in response to a determination being made that the corresponding service is not a multicast/broadcast service, maintaining current mode.

5. The method of claim 1, wherein the switching of the mode of the corresponding service comprises
if the number of counted terminals is greater than the predetermined threshold, determining whether or not the corresponding service is currently a multicast/broadcast service and
in response to a determination being made that the corresponding service is not a multicast/broadcast service, switching the mode of the corresponding service to multicast/broadcast mode.

6. The method of claim 1, wherein the switching of the mode of the corresponding service comprises if the number of counted terminals is greater than the predetermined threshold, determining whether the corresponding service is currently a multicast/broadcast service, and in response to a determination being made that the corresponding service is a multicast/broadcast service, maintain current mode.

7. A method of a base station to count a number of terminals, the method comprising:
receiving a request message from a multicast/broadcast server which requests counting of a number of terminals;
counting a number of terminals by transmitting and receiving signals to and from one or more terminals; and
transmitting the counting result to the multicast/broadcast server.

8. The method of claim 7, wherein the counting of the number of terminals comprises transmitting an inquiry message to the one or more terminals to ask whether the one or more terminals are provided with any services included in a service list contained in the request message or whether the one or more terminals are interested in the services included in the service list, and receiving a response message containing a list of services being currently provided or service of interest from the one or more terminals.

9. The method of claim 8, wherein the inquiry message is a multicast/broadcast scheduling information message to transmit multicast/broadcast scheduling information.

10. The method of claim 5, wherein the inquiry message includes time information about duration of time for which the counting is performed.
